(19) United States
(12) Patent Application Publication
(10) Pub. No.: US 2007/0157840 A1
(43) Pub. Date: Jul. 12, 2007

(54) Method for controlling the ink feed of an offset printing press for model based color control and printing press for carrying out the method

(75) Inventor: Martin Mayer, Ladenburg (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/637,593

(22) Filed: Dec. 12, 2006

(30) Foreign Application Priority Data
Jan. 12, 2006 (DE) 10 2006 001 588.6

(51) Int. Cl. B41F 33/00

(52) U.S. Cl. 101/484

(57) ABSTRACT

A method is provided for controlling an ink feed of an offset printing press having a control computer and at least one inking unit controlled by the control computer. The control computer calculates an ink layer thickness necessary for the color through the use of spectral reflectance values and, in order to set the calculated ink layer thickness, performs necessary setting operations on the inking unit. A printing press having an apparatus for carrying out the method is also provided.

### CROSS-REFERENCE TO RELATED APPLICATION

This application claims the priority, under 35 U.S.C. §119, of German Patent Application DE 10 2006 001 588.6, filed Jan. 12, 2006; the prior application is herewith incorporated by reference in its entirety.

### BACKGROUND OF THE INVENTION

### Field of the Invention

The present invention relates to a method and an apparatus for controlling the ink feed of an offset printing press, having a control computer and at least one inking unit controlled by the control computer.

An inking unit of an offset printing press is responsible for transferring an application of ink required for production of a printed image to plate cylinders, blanket cylinders and finally to printing material. There, use is made, inter alia, of ink fountains in the inking units, which permit the application of ink to be set in accordance with a desired result in various inking zones through the use of metering elements. In that case, it is primarily a matter that the application of ink on the printing material and therefore the printed image produced corresponds to the original. For that purpose, there are in the meantime a series of control systems in printing presses which compare actual color values of a produced printed image with the desired values of an original and then, in a control loop, control the ink feed of the inking unit of a printing press in an appropriate manner. The actual color values are normally registered on the printing material through the use of a color measuring instrument.

Such a color control system is disclosed in German Published, Non-Prosecuted Patent Application DE 100 13 876 A1, corresponding to U.S. Pat. No. 6,450,097. The printed image produced in that case can be measured in the printing press or outside the printing press. In German Published, Non-Prosecuted Patent Application DE 100 13 876 A1, corresponding to U.S. Pat. No. 6,450,097, during printing operation, the printing materials are registered by a color measuring device and the actual color values produced in that way are supplied to a color control device. There, the actual color value is compared with a desired color value, with a mathematical model being used to form an actuating variable which is supplied to an ink adjusting element, such as an ink metering element in the ink fountain. The inking can then be adapted in accordance with the desired color values through the use of that ink metering element. In addition, in the method according to German Published, Non-Prosecuted Patent Application DE 100 13 876 A1, corresponding to U.S. Pat. No. 6,450,097, additive superimposition of the change over time of preceding actuating variable changes is carried out in order to improve the control. The actual color values are converted into an actual ink layer thickness in the computer for the purpose of controlling the ink metering elements. The stored desired color values to be achieved are also converted into a desired ink layer thickness, in order to compare them with the actual ink layer thickness in the printing press. The actual color values are registered by the measuring instrument in a densitometric or calorimetric way. Thus, improved control is carried out during the inking in the printing press. The disadvantage of such a procedure resides in the fact that, in such a control system, appropriate effort has to be expended in order to be able to compensate for the control deviations as quickly as possible, so that as few rejects as possible are produced while color errors are being controlled out. In addition, in inking units in offset printing presses, it is only possible to perform the control very slowly, since the inking units exhibit a very slow control response.

### SUMMARY OF THE INVENTION

It is accordingly an object of the invention to provide a method for controlling the ink feed of an offset printing press for model based color control and a printing press for carrying out the method, which overcome the hereinafore-mentioned disadvantages of the heretofore-known methods and apparatuses of this general type and which permit the ink layer thickness in the inking unit of a printing press to be set in advance in such a way that as few rejects as possible accumulate.

With the foregoing and other objects in view there is provided, in accordance with the invention, a method for controlling an ink feed of an offset printing press having a control computer and at least one inking unit controlled by the control computer. The method comprises calculating, with the control computer, an ink layer thickness necessary for a color by using spectral reflectance values, and performing necessary setting operations on the inking unit to set the calculated ink layer thickness.

With the objects of the invention in view, there is also provided a printing press, comprising an apparatus for carrying out the method.

The method according to the invention can be carried out on any appropriately equipped offset printing press. Such an offset printing press expediently has a control computer which is capable of passing on control commands to ink metering elements in an inking unit of the offset printing press. To this end, the ink metering elements are normally driven by electric motors which are monitored by the control computer. In the present invention, the spectral reflectance values of printing materials and ink are used. These spectral reflectance values are converted into corresponding ink layer thicknesses by the control computer in an ink layer thickness model, so that the appropriate ink layer thicknesses can be set by the control computer in the inking units to be driven. The ink layer thickness model is a mathematical model which is installed in the form of software on the control computer of the printing press or on a computer connected to the printing press. This model offers the advantage that, due to the known spectral reflectance values for printing material and/or ink, it is possible to calculate particularly exactly, in advance, the necessary ink layer thicknesses which have to be established in the print in order to produce a printed image corresponding to the original. The spectral reflectance values of ink and printing material can firstly be taken from the data sheets of the manufacturer and can secondly be determined by measurement before printing. In this case, although complicated control through the use of a desired-actual value comparison is additionally possible, it is not absolutely necessary, since very precise control of the inking unit is carried out herein on the basis of spectral reflectance values. Reflectance signifies the intensity of light from the printing ink or the printing material, respectively. The calculated ink layer thicknesses in the individual inking units of the printing press can be used both for presetting the ink before printing and for the input of ink carried out before the actual printing.

In accordance with another mode of the invention, provision is made to ensure that, during the calculation of the ink layer thickness, the ink layer thickness to be calculated is related to a given ink layer thickness. In addition to the spectral reflectance values for ink and printing material, in this case a standard layer thickness is chosen at which the spectral reflectance of the ink and/or printing material was measured or which is to be taken from the data sheet. In this case, in addition to the spectral reflectance values of printing material and ink, the ink layer thickness model can also contain the standardized layer thickness. The ink layer thickness to be established is then the single unknown in the ink layer thickness model and can thus be calculated in order to set the inking unit. Furthermore, provision is made to ensure that, during the calculation of the ink layer thickness, the spectral reflectance value of the current printing material is related to a reflectance value of the ink. In this case too, the intention is for both the reflectance value of the ink and the reflectance value of the current printing material to go into the ink layer thickness model, so that the ink layer thickness to be established can be calculated in an appropriate way in order to control the inking unit.

In accordance with a further mode of the invention, provision is additionally made for densitometric desired color values to be calculated from the reflectance values. Alternatively, calorimetric desired color values can also be calculated from the reflectance values. As distinct from the prior art, where the desired color values have to be registered either densitometrically or calorimetrically through the use of a measuring instrument, in this case the appropriate colorimetric or densitometric desired color values are calculated directly from the reflectance data of ink and printing material and a standard ink layer thickness. The desired color values calculated in this way can then be processed further appropriately in a printing press corresponding to the prior art which operates with calorimetric or densitometric desired color values, without the control of the printing press having to be changed.

In accordance with an added mode of the invention, calorimetric or densitometric desired color values are calculated by using reflectance values for color and/or printing material measured with polarizing filters. In this case, the colorimetric or densitometric desired color values can also be calculated for reflectance values determined with polarizing filters. The appropriate desired color values can be determined in dependence on whether the operator of the printing press would rather work with or without polarizing filters.

In accordance with an additional mode of the invention, provision is made for the reflectance values for printing material or ink or the associated ink layer thickness to be entered into the control computer. The spectral reflectance values for printing material or ink and the associated ink layer thickness can be supplied at the same time, for example by the manufacturer of the ink or the printing material. In this case, the printer can enter the values supplied into the control computer of the printing press by hand or through the use of a data storage medium or network connection through an appropriate input unit such as a keyboard or mouse.

In accordance with yet another mode of the invention, provision is made for the reflectance values of printing material or ink or the associated ink layer thickness to be stored in the control computer. For example, the manufacturer of the printing press can store specific reflectance values for printing materials or ink and the associated ink layer thickness in the control computer as early as at the factory, so that the entry by hand or subsequently by the printer is not necessary, at least for familiar printing materials or printing inks. In this case, the printer can fall back directly on the data stored in the control computer.

In accordance with a concomitant mode of the invention, provision is made for the reflectance values for printing materials or ink to be registered through the use of a measuring instrument which is connected to the control computer. If the data for a printing material or a printing ink has neither been stored in the control computer of the printing press nor been supplied by the manufacturer, then a handheld measuring instrument or other measuring instrument can be connected to the printing press in order to register the reflectance values of the unknown ink or of the unknown printing material. However, in this case, the ink layer thickness cannot be determined. In this configuration, it is merely possible to specify what layer thickness change is required relative to a known state with an identical ink and paper combination. If layer thickness and reflectance spectrum are known, it is possible to specify what layer thickness changes are required relative to a known state with an identical printing material but changed ink. The use of the data stored in the control computer of the printing press or data entered by the printer, and also the data registered with a measuring instrument for reflectance values and ink layer thickness, can be carried out beside each other on one and the same printing press, depending on which printing materials or ink are used.

Other features which are considered as characteristic for the invention are set forth in the appended claims.

Although the invention is illustrated and described herein as embodied in a method for controlling the ink feed of an offset printing press for model based color control and a printing press for carrying out the method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, side-elevational view of a sheet fed rotary printing press having a control system according to the invention;

FIG. 2A is a diagram showing the course of the calorimetric L value over the associated ink layer thickness;

FIG. 2B is a diagram showing the course of the calorimetric a value over the ink layer thickness; and

FIG. 2C is a diagram showing the course of the calorimetric b value over the ink layer thickness.

### DESCRIPTION OF THE PREFERRED EMBODIMENTS

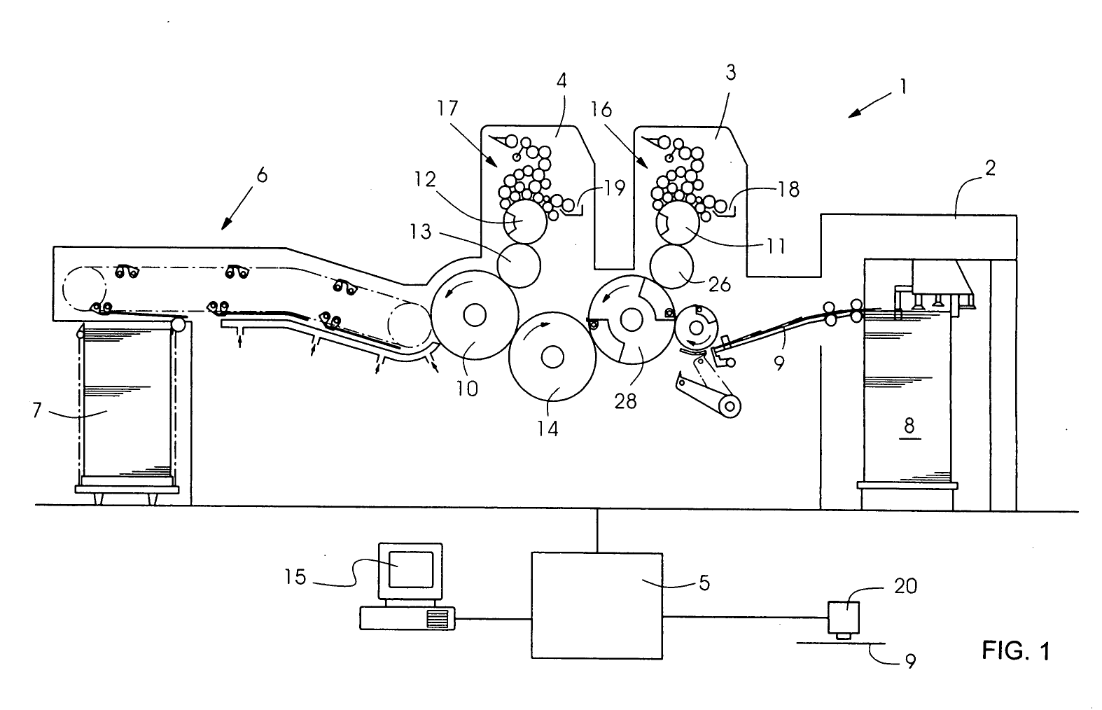

Referring now to the figures of the drawings in detail and first, particularly, to FIG. 1 thereof, there is seen a printing press 1 which has first and second printing units 3, 4, a feeder 2 and a delivery 6. In the feeder 2, sheet printing materials 9 are removed from a feeder stack 8 and supplied over a suction belt to the first printing unit 3 of the printing press 1. There, the sheets 9 are printed in a press nip between an impression cylinder 28 and a blanket cylinder 26 and, through the use of a transport cylinder 14, are transferred to the following second printing unit 4. There, the same sheet 9 is printed with a second color print in a second press nip between an impression cylinder 10 and a blanket cylinder 13 and is transferred to the delivery 6. In the delivery 6, the printed sheets 9 are deposited on a delivery stack 7. The two printing units 3, 4 each have an inking unit 16, 17 which supplies plate cylinders 11, 12 with printing ink. In addition, the two printing units 3, 4 each have a dampening unit 18, 19, which is used to influence the viscosity of the ink provided in the inking units 16, 17. In the inking units 16, 17, the applications of ink to rolls of the inking units 16, 17 can be controlled appropriately through the use of electrically controlled ink metering elements. The inking units 16, 17 are connected to a control computer 5 of the printing press 1, which monitors all actuating drives and drive motors of the printing press 1.

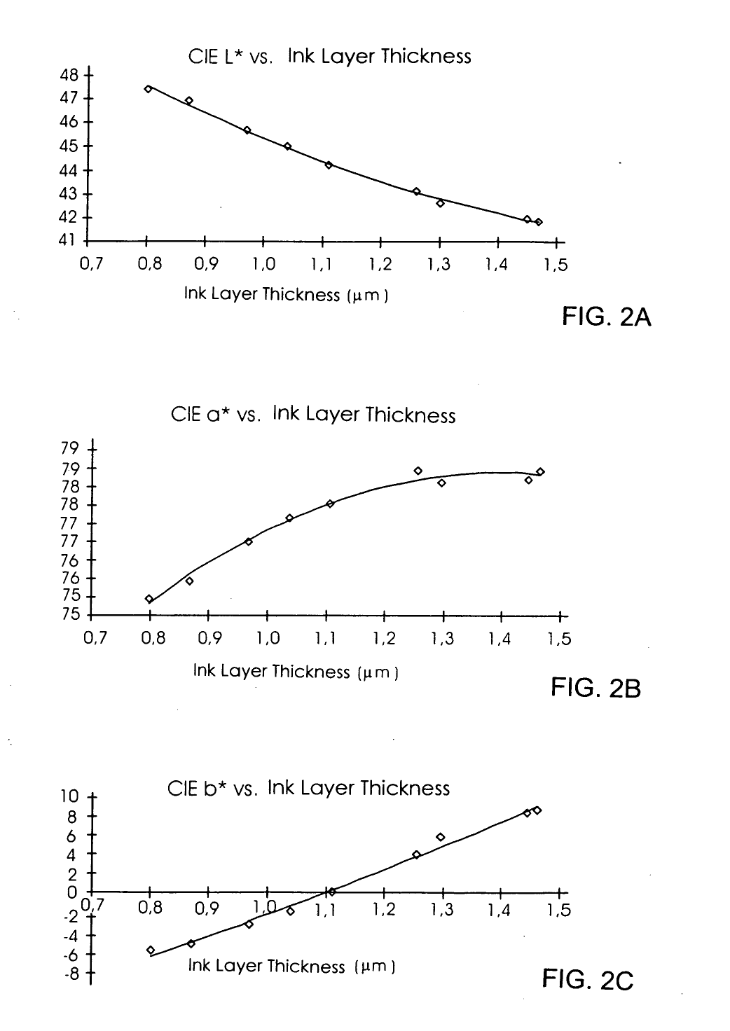

Operating personnel are able to enter data into the control computer 5 through a monitor 15 having a keyboard or a touch screen or be informed with respect to the operating state of the printing press 1 through appropriate status messages. Additionally depicted in FIG. 1 is a handheld measuring instrument 20, with which sheets 9 can be measured calorimetrically or densitometrically. Corresponding spectral reflectance values β₀, β_{PW} for familiar printing materials and printing inks from various manufacturers are already stored in the control computer 5 of the printing press 1, so that they have to be supplemented by manual entries by the printing personnel only in the case of unusual printing materials or printing inks. This can be done through the keyboard on the monitor 15. Furthermore, there is an ink layer thickness model in the form of software on the control computer 5, which permits the spectral reflectance values β₀, β_{PW} of printing material and ink as well as ink layer thicknesses S₁ corresponding to a standard ink layer thickness S₀ to be calculated for the setting of the inking units 16, 17 in the individual printing units 3, 4. Additionally, the control computer 5 can also use the reflectance values β₀, β_{PW} and the standard ink layer thickness S₀ to calculate densitometric desired color values DV or calorimetric desired color values L, a, b in addition to the ink layer thickness S₁ to be calculated. In this case, the control system of the printing press 1 can fall back on the densitometric or calorimetric desired color values calculated in this way, for example during subsequent desired-actual value control. The relationship between calorimetric desired color values L, a, b and the respective calculated ink layer thicknesses is shown by FIGS. 2A, 2B and 2C.

In order to adapt the color control functions to new desired values, firstly the relationship between ink layer thickness S₁ and color must be determined. This is achieved through the use of an ink layer thickness model, which is implemented on the control computer 5 and which is based on the spectral reflectance of the ink β₀(λ) at a layer thickness S₀ and the spectral reflectance of the printing material β_{PW}(λ). In the simplest case, it is assumed for the ink layer thickness model that the spectral reflectance in relation to paper white is influenced only by extinction:

$$β ( λ ) = {β}_{PW} ( λ ) \cdot {( \frac{{β}_{0} ( λ )}{{β}_{PW} ( λ )} )}^{S 0 / S 1} \qquad Equation 1$$

However, more complicated models, for example based on the studies of Kubelka and Munk, are also possible, which additionally also take into account the scattering behavior on the paper and the ink surface, for example. Both densitometric and calorimetric color values can then be calculated from the reflectance curve.

Example of calorimetric CIE (International Commission on Illumination) L, a, b values:

$${L}^{*} = 116 \cdot {Y}^{*} - 16$$

$${a}^{*} = 500 \cdot ( {X}^{*} - {Y}^{*} )$$

$${b}^{*} = 200 \cdot ( {Y}^{*} - {Z}^{*} )$$

$${X}^{*} = \{ \begin{matrix}\sqrt[3]{X / {X}_{n}} for X / {X}_{n} > 0.008856 \\ 0.787 \cdot X / {X}_{n} + 0.138 for X / {X}_{n} \leq 0.008856\end{matrix} \}$$

$${Y}^{*} = \{ \begin{matrix}\sqrt[3]{Y / {Y}_{n}} for Y / {Y}_{n} > 0.008856 \\ 0.787 \cdot Y / {Y}_{n} + 0.138 for Y / {Y}_{n} \leq 0.008856\end{matrix} \}$$

$${Z}^{*} = \{ \begin{matrix}\sqrt[3]{Z / {Z}_{n}} for Z / {Z}_{n} > 0.008856 \\ 0.787 \cdot Z / {Z}_{n} + 0.138 for Z / {Z}_{n} \leq 0.008856\end{matrix} \}$$

$$X = {K}_{x} \cdot \int S ( λ ) \cdot β ( λ ) \cdot \overline{x} ( λ ) d λ$$

$$Y = {K}_{y} \cdot \int S ( λ ) \cdot β ( λ ) \cdot \overline{y} ( λ ) d λ$$

$$Z = {K}_{z} \cdot \int S ( λ ) \cdot β ( λ ) \cdot \overline{z} ( λ ) d λ$$

where:
S(λ) is the radiation function of the standard type of light
x̅(λ), y̅(λ), z̅(λ) are standard spectral value functions
Xₙ, Yₙ, Zₙ are constants depending on the type of light and viewer angle

The desired value can be calculated for each desired type of light (D65, D50, A, xenon, . . . ) by using the type of light-specific radiation function S(λ).

Example of the density values DV:

$$DV = - {log}_{10} ( \frac{\int β ( λ ) \cdot F ( λ ) d λ}{\int {β}_{PW} ( λ ) \cdot F ( λ ) d λ} )$$

The density value can be calculated for each color filter (cyan, magenta, yellow, black) and each filter function (DIN, DIN narrow band, ANSI A, ANSI T, . . . ) by using the spectral filter function F(λ). If the spectral reflectance of ink and paper β₀, β_{PW} is available both with and without polarization filter measurement, the calorimetric and densitometric desired values L, a, b, DV can also be calculated for these two measuring conditions.

The spectral reflectance of printing material and ink β₀, β_{PW} and the associated ink layer thickness S₀ can originate from a number of sources. They are supplied by the ink manufacturer with the ink, they are stored in the color control system or they are registered by a measuring instrument 20.

In the case of registration by measurement, the ink layer thickness cannot be determined. In this case, it is merely possible to specify what layer thickness change relative to a known state is required in the case of an identical ink and paper combination. If layer thickness and reflectance spectrum are known, it is possible to specify what layer thickness change relative to a known state is required in the case of an identical printing material but a changed ink. Since there is not a uniform solution for determining the layer thickness S₁ in the case of a desired color, either in the case of densitometric or calorimetric desired values L, a, b, DV, it is expedient to use equation 1 and the calculation method mentioned above for 3 to 4 layer thicknesses to calculate the coloration in the area relevant to the printing. If the coloration curve is approximated, for example through the use of a second order polynomial, then in the case of densitometric desired values DV it is possible to solve directly for the desired layer thickness.

In the case of calorimetric desired values L, a, b, the relationship between ink layer thickness and L, a, b can be determined firstly by regression methods and the color error in relation to the desired color can then be determined, or the color error in relation to the desired color is calculated directly and that relationship is approximated through the use of a regression method. Other methods are also conceivable, for example in accordance with sensitivity matrices used in the measuring instruments.

After the ink layer thickness SD_{new} required for the desired color has been determined, this is related to the ink layer thickness SD_{old} for which ink presetting and ink input have been determined. In the simplest case, linear scaling of the inking zones of the ink presetting from FZ_{old} to FZ_{new} is carried out:

$${FZ}_{new} = {FZ}_{old} \frac{{SD}_{new}}{{SD}_{old}}$$

Through the use of the planned coupling of the ink input 1 with the ink presetting, the ink input is likewise matched to the new desired color value.

In addition to the linear scaling of the inking zones, adaptation in accordance with the metering characteristics of the ink fountain is also possible.

I claim:

1. A method for controlling an ink feed of an offset printing press having a control computer and at least one inking unit controlled by the control computer, the method comprising the following steps:
calculating, with the control computer, an ink layer thickness necessary for a color by using spectral reflectance values; and
performing necessary setting operations on the inking unit, with the control computer, to set the calculated ink layer thickness.

2. The method according to claim 1, which further comprises relating the ink layer thickness to be calculated to a given ink layer thickness, during the step of calculating the ink layer thickness.

3. The method according to claim 1, which further comprises relating the spectral reflectance value of the current printing material to a reflectance value of the ink, during the step of calculating the ink layer thickness.

4. The method according to claim 1, which further comprises calculating densitometric desired color values from the reflectance values.

5. The method according to claim 1, which further comprises calculating colorimetric desired color values from the reflectance values.

6. The method according to claim 1, which further comprises calculating calorimetric or densitometric desired color values by using reflectance values for ink and/or printing material measured by using polarizing filters.

7. The method according to claim 1, which further comprises entering the reflectance values for printing material or ink or the associated ink layer thickness into the control computer.

8. The method according to claim 1, which further comprises storing the reflectance values for printing material or ink or the associated ink layer thickness in the control computer.

9. The method according to claim 1, which further comprises registering the reflectance values for printing material or ink with a measuring instrument connected to the control computer.

10. A printing press, comprising an apparatus for carrying out the method according to claim 1.
